(19) United States
(12) Patent Application Publication
(10) Pub. No.: US 2009/0180180 A1
(43) Pub. Date: Jul. 16, 2009

(54) Sub-pixel optical array

(75) Inventors: Liran Shimshi, Ramat-Gan (IL); Sharon Sade, Kfar-Yona (IL); Noam Sorek, Zikhron-Yaakov (IL)

Correspondence Address: MARTIN D. MOYNIHAN d/b/a PRTSI, INC., P.O. BOX 16446, ARLINGTON, VA, 22215, US

(73) Assignee: Samsung Electronics Co., Ltd., Gyeonggi-do (KR)

(21) Appl. No.: 12/222,947

(22) Filed: Aug. 20, 2008

Related U.S. Application Data
(63) Continuation-in-part of application No. 12/007,879, filed on Jan. 16, 2008.

(51) Int. Cl. G02B 27/22; G02B 27/44

(52) U.S. Cl. 359/462; 359/566

(57) ABSTRACT

An apparatus for displaying media data comprising digital display and an optical element configured for diffracting a plurality of monochromatic light beams impinging from the display to form a plurality of monochromatic images of the media data. The chromatic image and the monochromatic images having substantially equal resolution.

### RELATIONSHIP TO EXISTING APPLICATIONS

This application is a continuation-in-part of U.S. patent application Ser. No. 12/007,879, filed on Jan. 16, 2008, the contents of which are hereby incorporated by reference.

### FIELD AND BACKGROUND OF THE PRESENT INVENTION

The present invention, in some embodiments thereof, relates to optical systems and, more particularly, but not exclusively, to optical systems for manipulating images.

The present invention is applicable to, but not limited to, cellular phones and other mobile handheld devices. Other applications may include, but are not limited to, image projectors, both stand alone and incorporated into cellular phones and other handheld devices.

A typical digital display for displaying media data is based on a panel that contains a plurality of display elements, such as a plurality of light sources that project light toward one or more points of view. Each display element, which may be referred to herein as a pixel, comprises several chromatic sub-elements, typically red, green and blue. Each pixel may be made of active elements that emit light or passive elements that reflect or transfer impinging light.

Flat panel display technologies includes liquid crystal display (LCD), thin film transistor (TFT), liquid crystal on silicon (LCOS), Plasma, light-emitting diode (LED), Organic LED, (OLED), surface-conduction electron-emitter display (SED), electro luminescence (EL), vacuum fluorescence (VF). Many more technologies are emerging.

Additional optical sub-systems may be used for manipulating the light projected out of the display. Optical processing may be used for creating a uniform backlight and/or for correcting optical aberrations both in the display system and/or in the observer side. Optical processing is also used for limiting and/or broadening the angle of view of the display, as well as for creating broadened 2-D and 3-D displays.

Usually, the displayed image is manipulated as a whole. Such manipulation has a relatively limited functionality and performance. Furthermore, such optical manipulation may not be easily implemented in system that is adapted to variety of optical conditions. In addition, implementing such a manipulation is typically bulky and do not fit to a device with a limited size, such as a cellular phone.

### SUMMARY OF THE PRESENT INVENTION

According to some embodiments of the present invention there is provided an apparatus for displaying media data. The apparatus comprises a digital display configured for emitting a plurality of monochromatic light beams to produce a chromatic image of the media data and an optical element configured for diffracting the plurality of monochromatic light beams to form a plurality of monochromatic images of the media data. The chromatic image and each the monochromatic image having substantially equal resolution.

Optionally, the optical element configured is configured for diffracting one of the plurality of monochromatic images toward a left eye of an observer and a second of the plurality of monochromatic images toward a right eye of the observer.

Optionally, the digital display comprises a plurality of sub pixels each configured for separately emitting one of the plurality of monochromatic light beams.

More optionally, a first group of the plurality of sub pixels is configured for emitting light centered on a first wavelength and a second group of the plurality of sub pixels is configured for emitting light centered on a second wavelength, the optical element configured for diffracting each the monochromatic light beam according to respective the first or second wavelength.

Optionally, the plurality of monochromatic images are diffracted to merge to form an additional chromatic image.

Optionally, the optical element comprises of plurality of optical sub-elements overlaying the display.

More optionally, each the optical sub-element is associated with a different pixel of the display, each the optical sub-element being positioned to diffract light emitted from the associated pixel.

More optionally, at least one of the plurality of optical sub-elements is associated with a different group of adjacent pixels of the display, each the at least one optical sub-element being positioned to diffract light emitted from the different group of pixels.

More optionally, each the at least one optical sub-element is configured for diffracting the emitted light to a plurality of directions.

More optionally, at least one of the optical sub-element is associated with a different chromatic sub-pixel element of a pixel of the display, each the at least one optical sub-element being positioned to diffract light emitted from the associated chromatic sub-pixel.

More optionally, the optical sub-elements have a movement capability relative to the display.

More optionally, the movement capability allows each the optical sub-element to move separately from each other.

More optionally, the movement capability is configured to displace at least one of the plurality of optical sub-elements between overlaying an active area of the display and a passive area of the display.

Optionally, the optical element comprises at least one micro-prism.

Optionally, the optical element comprises at least one diffraction grating optical element.

Optionally, the optical element comprises first and second groups of a plurality of optical sub-elements, each optical sub-element of the first group being configured for diffracting one of the plurality of monochromatic light beams toward a first direction and each optical sub-element of the second group being configured for diffracting at least one of the plurality of monochromatic light beams toward a second direction.

More optionally, the first and second groups are arranged in a single layer.

More optionally, the optical element creates a stereoscopic 3D display.

Optionally, the digital display comprises a plurality of picture elements and the optical element comprises a plurality of sub elements each associated with a receptive the picture element, each the sub element being configured for diffracting a plurality of light waves emitted from the respective picture element toward a POV, thereby manipulating a perceived distance of the digital display for an observer at the POV, the perceived distance being different from the actual distance.

Optionally, each the picture element is a pixel.

Optionally, each the picture element is a sub-pixel.

According to some embodiments of the present invention there is provided a method for displaying media data, comprising emitting a plurality of monochromatic light beams to produce a chromatic image of the media data and diffracting the plurality of monochromatic light beams to form a plurality of monochromatic images of the media data. The chromatic image and each the monochromatic image having substantially equal resolution.

Optionally, the diffraction of the plurality of monochromatic light beams is performed by plurality of optical sub-elements.

More optionally, the method further comprises moving an optical element for changing the position of at least one of the plurality of monochromatic images.

More optionally, the optical element comprises a plurality of optical sub elements, the moving comprises moving a group of the optical sub elements for changing the position of a selected image of the plurality of monochromatic images.

More optionally, the moving comprises moving the group from an active area to a passive area.

Optionally, a first group of the plurality of monochromatic light beams are refract toward a left eye of an observer and second group of the plurality of monochromatic light beams being refract toward a right eye of the observer, wherein the first and second groups form a stereoscopic 3D image of the media data.

Unless otherwise defined, all technical and/or scientific terms used herein have the same meaning as commonly understood by one of ordinary skill in the art to which the present invention pertains. Although methods and materials similar or equivalent to those described herein may be used in the practice or testing of embodiments of the present invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference now to the drawings in detail, it is stressed that the particulars shown are by way of example and for purposes of illustrative discussion of embodiments of the present invention. In this regard, the description taken with the drawings makes apparent to those skilled in the art how embodiments of the present invention may be practiced.

In the drawings:

FIG. 1 is schematic top view of an LCD display according to an exemplary embodiment of the present invention;

FIG. 2 is cross section view of the LCD display illustrated in FIG. 1;

FIGS. 3A-3E illustrates several arrangements of optical sub-elements, according to exemplary embodiments of the present invention;

FIG. 4A is an illustration of sub-pixel micro-prism optical element arrangement according to an exemplary embodiment of the present invention;

FIG. 4B is an illustration of sub-pixel diffraction grating optical element arrangement according to an exemplary embodiment of the present invention;

FIG. 5A is an illustration of sub-pixel micro-prism optical element arrangement with elements displacement capabilities according to an exemplary embodiment of the present invention;

FIG. 5B is a schematic illustration of sub-pixel diffraction gratings optical element arrangement with elements displacement capabilities according to an exemplary embodiment of the present invention;

FIG. 6 is a schematic illustration of a pixel arrangement which splits pixel's light using micro-prisms according to an exemplary embodiment of the present invention;

FIG. 7 is a schematic illustration of a sub-pixel arrangement which splits sub-pixel's light using diffraction gratings optical elements according to an exemplary embodiment of the present invention;

FIGS. 8A-8C are illustrations of possible optical manipulations of the optical sub-elements in accordance with exemplary embodiments of the present invention;

FIG. 9 is an illustration of light trajectories in a 2D display mode according to exemplary embodiments of the present invention;

FIG. 10 is a schematic illustration of light trajectories in a 3D display mode according to exemplary embodiments of the present invention;

FIGS. 11A-11B are illustrations of light trajectories in time interlaced 3D display mode according to exemplary embodiments of the present invention;

FIG. 12 is a flowchart of a method for implementing multi-mode 2D/3D display, according to exemplary embodiments of the present invention.

FIG. 13A is a known schematic illustration of trajectories of light beams emitted from image projectors; and

FIG. 13B is a schematic illustration of trajectories of light beams emitted from image projectors, according to exemplary embodiments of the present invention;

FIG. 14 is a schematic illustration of an imaging device, according to some embodiments of the present invention; and

FIG. 15 is a schematic illustration of an exemplary optical sub-element that is positioned in front of a picture element of the display of the imaging device of FIG. 14, according to one embodiment of the present invention.

### DESCRIPTION OF SPECIFIC EMBODIMENTS OF THE PRESENT INVENTION

The present invention, in some embodiments thereof, relates to optical systems and, more particularly, but not exclusively, to optical systems for manipulating images. The present invention is applicable to, but not limited to imaging units of cellular phones and other handheld devices. Other applications include, but are not limited to, image projectors, both stand alone and incorporated into cellular phones and other handheld devices.

According to some aspects of the present invention, there is provided an apparatus comprising an optical element which is designed to be positioned in front of a digital display for displaying media data. The digital display comprises a panel with pixel array. The optical element comprises a plurality of optical sub-elements. Optionally, each optical sub-element is associated with one or more different pixels of the display. Optionally, each optical sub-element is associated with one or more chromatic sub-pixels. For example, each chromatic sub-pixel of the pixel is associated with a different optical sub-element. In such an embodiment, the red, green and blue light may be deflected in different directions by different optical sub-element. Alternatively, two optical sub-elements are associated with chromatic sub-pixel. In such an embodiment, each chromatic sub-pixel light may be split and deflected to two different directions.

According to some aspects of the present invention, the digital display is designed for emitting a plurality of monochromatic light beams, which produce a chromatic image of the media data on the observer eyes. The optical element is designed for diffracting the plurality of monochromatic light beams to form a plurality of monochromatic images. The chromatic image and each one of the monochromatic images having substantially equal resolution. For example, in digital projectors having a lens sub-system to project and focus the data on a screen, creating plurality of monochromatic images may be used to correct the chromatic aberration generated by the lens sub-system. According to some embodiments of the present invention, each optical sub-element is adapted to manipulate the light differently. Optionally, some or more of the optical sub-elements may be moved from covering an active display element to cover a non active display area and vice versa.

According to some embodiments of the present invention, the active display element projects wideband (white-colored) light and the optical sub-elements filter and deflect plurality of monochromatic light waves therefrom. The created chromatic images and the original wideband non-chromatic image have substantially equal resolution. Optionally, each one of the optical sub-elements may control the intensity of the monochromatic light wave by changing its position with respect to the active display element. Additionally or alternatively, each white-colored pixel associated with plurality of optical sub-elements creating plurality of chromatic light waves each comprises from several monochromatic light waves. The created chromatic images, in this exemplary embodiment, have higher resolution then the original wideband non-chromatic image. Alternatively or optionally, the intensity of each monochromatic light wave is controlled by dividing the active display pixel to plurality of white light emitting sub-pixels. Each sub-pixel associate with an optical sub-element which filters and deflects only one chromatic light. The intensity of the chromatic light may be adjusted by the manipulating the optical sub-elements, for example as described below. In such a manner, the optical sub-elements create convert the white light to monochromatic light beams and optionally adjust the intensity thereof.

According to some embodiments of the present invention, the optical sub-elements are diffractive optics elements. Optionally, the diffractive optics elements comprise diffraction grating elements. For example, a 16 micron wide sub-pixel may be covered with diffraction grating element that contains 160 grooves. That creates a diffraction grating element with grooves density between ¼ and 1/7 of a visible light wavelength.

According to some embodiments of the present invention, the optical manipulation includes diverting the impinged light waves. Optionally, the optical sub-element may be moved among plurality of positions. In each position the optical sub-element may divert light in a different manner.

According to some embodiments of the present invention, the optical manipulation includes splitting impinged light wave to create two new wave-fronts which are projected in different directions. Optionally, by displacing the optical sub-element the direction of these wave-fronts is altered.

According to some embodiments of the present invention, the optical sub-element array is used in implementation of optical aberration correction for the display system. Optionally, the optical sub-element array may be used in implementation of display adapted correction for human eye vision aberration such as near-sightedness and far-sightedness. Optionally, the optical sub-element array may be used for limiting and/or broadening the angle of view of a display and for implementing 3D displays.

Optionally, the optical sub-element array, which is optionally a DOE, is laid over a display having white pixels. In such an embodiment, the DOE disperses the white color into one or more colors to increase resolution. Such an increase is based on dispersing the white light that is emitted from adjacent white pixels. Optionally, the DOE has different sections each adjusted to diffract light which is centered on a different wavelength and/or the angle in which the light is diffracted. In such an embodiment, moving the DOE in relation to the display may changes the intensity and/or the color of the formed image.

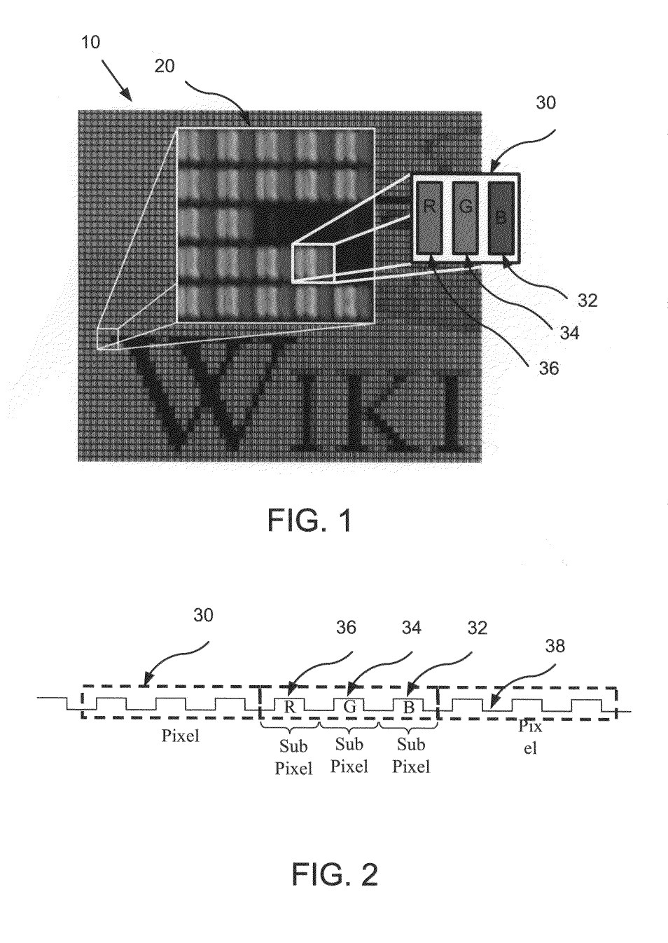

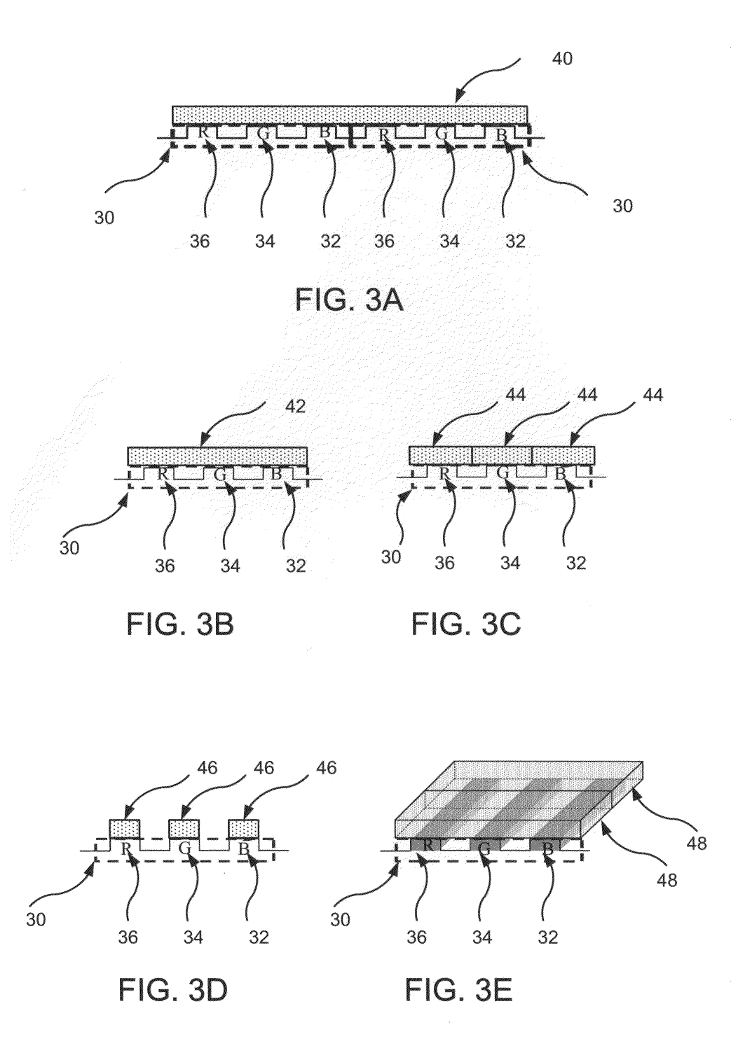

For purposes of better understanding some embodiments of the present invention, as illustrated in FIGS. 3-12 of the drawings, reference is first made to the construction and operation of a digital display as illustrated in FIGS. 1 and 2.

Referring now to the drawings, FIG. 1 is a schematic illustration of a top view of typical digital display 10, according to some embodiments of the present invention. The digital display 10 comprises an array of pixels 30.

Area 20 is close-up view if 5×5 pixels. Area 30 is a close-up view of one pixel. Pixel 30 comprises from three projection areas. Area 32, referred hereafter blue sub-pixel, is projecting blue color. Area 34, referred hereafter green sub-pixel, is projecting green color. Area 36, referred hereafter red sub-pixel, is projecting red color. In area 20, some pixels are projecting simultaneously red, green and blue colors to create illusion of white color projected by the pixel, while in other pixels in area 20 none of the sub-pixels 32, 34 and 36 are projecting light creating the illusion of black color projected by the pixel.

Reference is now made to FIG. 2, which is a cross section view illustration of display 10 according to an exemplary embodiment of the present invention. Three pixels 30 are illustrated in FIG. 2. Each pixel 30 comprises from the red, green and blue sub-pixels 36, 34 and 32 respectively. Area 38, referred hereafter non emitting zone or “dead-zone”, is lying between the sub-pixels and in many cases can occupy up to half of the area of the display.

In an exemplary embodiment of the present invention, a 2.5″ cellular phone LCD display with 2″ wide and VGA resolution, i.e. 640×480 pixels, is used. Pixel width is about 100μ. Each sub pixel is about 16 microns wide. The dead-zone between two adjacent sub-pixels is also about 16 microns wide.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Reference is now made to FIGS. 3A-3E, which are cross section view illustrations of display 10, according to different versions of exemplary embodiments of the present invention. According to an exemplary embodiment of the present invention, the display is covered with plurality of optical sub-elements 40-48 laying directly over the pixels 30. Optionally, the optical sub-elements are integrated part of the pixels. FIG. 3A is a cross section view of display 10 that illustrates an optical sub-element 40 which is laid over two adjacent pixels 30 of display 10. Optionally, the optical sub-element covers any number of pixels. For example, the above mentioned VGA display may be covered by 160×120 optical sub-elements, each covers 4×4 pixels. The optical sub-element deployment may have a non square shape, such as a rectangular shape, circular shape, or any other geometric shape.

FIG. 3B is a cross section view of display 10, which illustrates an arrangement with a single optical sub-element 42 which covers single pixel 30 comprises of red sub-pixel 36, green sub-pixel 34 and blue sub-pixel 32. In this arrangement the light emitted from each pixel may be manipulated independently by each of a respective optical sub-element 32, 34, 36.

FIG. 3C is a cross section view of display 10, which illustrates an arrangement with three optical sub-elements 44, each covers a single chromatic sub-pixel 32, 34 or 36. In such an arrangement, the light emitted from each chromatic sub-pixel may be manipulated independently each by a different optical sub-element. As further described below, this arrangement opens the opportunity for easy handling of chromatic aberration correction and other chromatic related optical processing.

FIG. 3D is a cross section view of display 10 that illustrates an arrangement where three optical sub-elements 46, each cover a single chromatic sub-pixel 32, 34 or 36. In this arrangement, the optical sub-element is laying only over the active area and not over the dead-zones.

FIG. 3E is an isometric view of display 10 that illustrates arrangement where two optical sub-elements 48 are deployed in each pixel 30. Each optical sub-element covers half of each chromatic sub-pixel areas 32, 34 and 36, consequentially, each optical sub-element covers half of pixel area 30 as well. In this arrangement, the light wave emitted from each pixel may be manipulated differently by each optical sub-element. For example, Light may be projected from each pixel to two different directions.

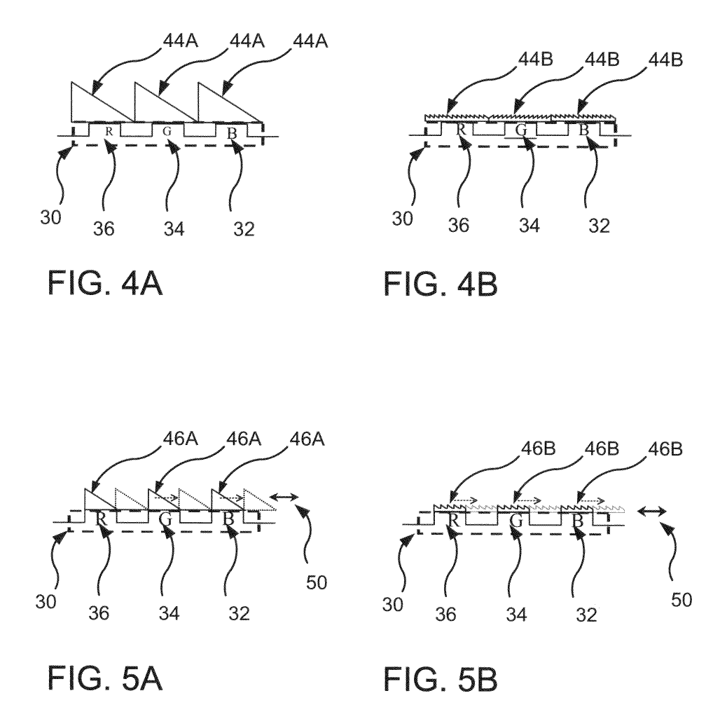

Reference is now made to FIG. 4. FIG. 4 illustrates an arrangement comprising optical sub-element for each pixel (same arrangement that is illustrated in FIG. 3C, where a specific optical sub-elements, micro-prisms are used in according to some exemplary embodiment of the present invention. Each pixel 30 is covered with three micro-prisms 44A. First micro-prism is laying over blue sub-pixel element 32, second micro-prism is laying over green sub-pixel element 34, and the third micro-prism is laying over red sub-pixel element 36.

FIG. 4B illustrates an exemplary embodiment of the present invention where the optical sub-elements are diffraction gratings optical element, refer hereinafter DGOE. Each pixel 30 is covered with three diffraction grating optical elements 44B. Diffraction grating optical elements is made of regular pattern of diffractive sub-elements, such as lines, holes or grooves. The deflection of the light is dictated by the diffractive sub-element density, the equation describing the diffraction angles is:

sin θᵢ+sin θ_{d}=nλv Equation 1:

where θᵢ denotes the angle of incidence and θ_{d} denotes the angle of diffraction. v is the line density of a diffractive sub-element, λ denotes the wavelength of the light wave impinging the diffractive sub-element, and n denotes the order of diffraction of the transmitted wave. Aforementioned Equation 1 provides an approximation for a simple DGOE. Optionally, grooves geometry and density may vary. In such an embodiment, solving of Maxwell equation may be needed to determine the outcome wave fronts. In these optical device selecting deflection direction as well as chromatic filtering and other optical processing is possible.

In an exemplary embodiment of the present invention, the sub-pixel active area width is 16 micron and the diffractive density is 10,000 lines/mm. Each sub-pixel diffractive elements contains 160 grooves. Alternatively, number of grove is 1, 10, 50, 100, 200, 500 and 1000 as well as individual numbers within that range is used.

Reference is now made to FIGS. 5A and 5B which illustrate arrangements similar to the one illustrated in FIG. 3D containing optical sub-element for each pixel; however the optical sub-elements in these exemplary embodiments of the present invention are moveable.

FIG. 5A illustrates an arrangement with micro-prism 46A located over each sub-pixel active area 32, 34 and 36. Each micro-prism 46A diffracts the light projected for the sub-pixel it covers. Micro-prisms 46A displacement is controlled in such a way that each micro-prism 46A may be either covering sub-pixels 32, 34, or 36 or covering the dead-zone adjacent to each sub-pixel 32, 34 and 36. The optical sub-element movement is in parallel to axes 50. FIG. 5B illustrates an arrangement with diffractive optics element (DOE) 46B located over each sub-pixel active area 32, 34 and 36. Each DOE 46B diffracts the light projected for the sub-pixel it covers. Micro-prisms 46B displacement is controlled in such a way that each DOA 46B may be either covering sub-pixels 32, 34, or 36 or covering the dead-zone adjacent to each sub-pixel 32, 34 and 36. The DOE movement is in parallel to axes 50.

In an exemplary embodiment of the present invention, as shown at FIG. 5A and FIG. 5B, the movement axis of the DOE is parallel to the display surface, as shown at 50. Alternatively or optionally, the optical sub elements may be (a) rotated in any direction relative to the display; (b) moved along a plane which is parallel to the display; and (c) moved along an axis perpendicular to the display. The optical sub elements movement allows a manipulation with two, three and up to six degrees of freedom per pixel.

In an exemplary embodiment of the present invention, the system illustrated on FIG. 5A and FIG. 5B may switch each optical sub-element on and off. In this case, in one state the light is projected directly out of the pixel while in the other state light is deflected toward a specific direction before projected out of the sub-pixel. In the display level it is possible to control all pixels coherently or each optical sub-element separately. Alternatively, specific chromatic elements, for example elements that emit light which is centered on a specific wavelength, may be controlled coherently for diffracting each said monochromatic light beam according to respective wavelength. Optionally, other specific pixel group such as specific area on screen may be controlled coherently for diffracting each group to a desired direction.

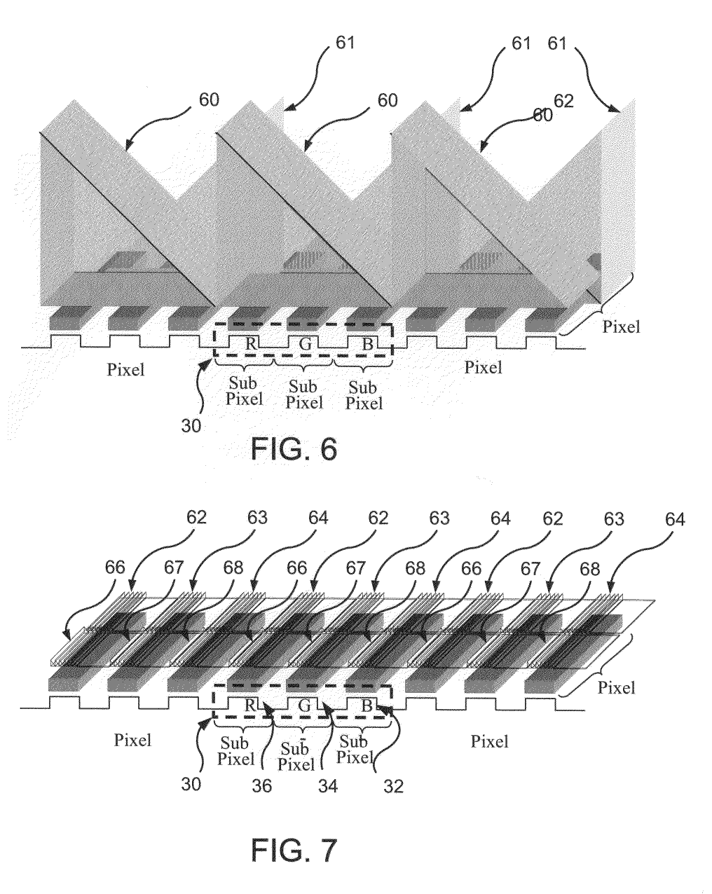

Reference is now made to FIG. 6, which is an isometric view illustration of image splitting arrangement according to exemplary embodiments of the present invention.

Two micro-prisms 60 and 61 are deployed on each pixel 30. Each micro-prism 60 and 61 covers half of each chromatic sub-pixel areas 32, 34 and 36. Consequentially, each micro-prism 60 and 61 covers half of pixel area 30 as well. Micro-prism 60 and Micro-prism 61 are arranged in opposite direction. Alternatively, different shape or other type of micro-prism or other optical sub-element may be used. In such optical sub-element arrangement, light splitting of a single pixel is achieved without using partially reflecting surfaces. This arrangement allows the diversion of light emitted from the array to form two images. Such an arrangement may be used for creating two images for 3D display and/or correcting optical aberrations.

Reference is now made to FIG. 7, which is an isometric view illustration of image splitting arrangement according to an exemplary embodiment of the present invention. Six DGOEs 62, 63, 64, 66, 67 and 68 are deployed on each pixel 30. DGOE 62 covers half of red sub-pixel 36. DGOE 63 covers half of green sub-pixel 34. DGOE 64 covers half of blue sub-pixel 32. DGOE 66 covers half of red sub-pixel 36. DGOE 67 covers half of green sub-pixel 34. DGOE 68 covers half of blue sub-pixel 34. An advantage of this arrangement is that light splitting of a single pixel is achieved without the use of partially reflecting surfaces. Furthermore, such an arrangement allows the forming of six separated images, two for each chromatic element. Such an arrangement may be used for correcting of chromatic aberrations such as lateral color aberration.

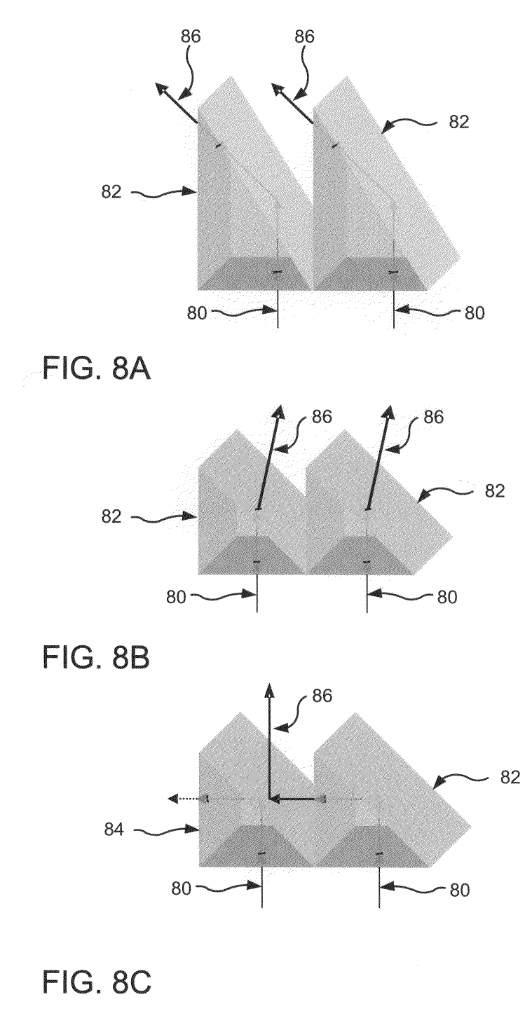

Reference is now made to FIGS. 8A-8C each illustrates a different possible optical manipulation realized by micro-prisms as the optical sub-elements, according to some embodiments of the present invention. Other optical sub-elements, such as diffractive optical elements, may be used to achieve similar optical manipulations.

As depicted in FIG. 8A, light deflection by reflection of light from micro-prism 82 is illustrated. Impinging light wave 80 enter a micro-prism 82 on the first face. The light is reflected from the opposing face of micro-prism 82 and travels to the exiting face. The light, which is optionally refracted from exiting face, leaves micro-prism 82 with deflected direction relative to the impinging direction.

In FIG. 8B, light deflection by refraction of light from the micro-prism 82 is illustrated. Impinging light wave 80 enters micro-prism 82 on the first face. The light is refracted from the opposing face of micro-prism 82 and leaves micro-prism 82 with deflected direction.

In FIG. 8C, light deflection by dual reflection from the micro-prisms is illustrated. Impinging light wave 80 enters micro-prism 82 on the first face. The light is reflected from the opposing face of micro-prism 82 and travel to the exiting face of micro-prism 82. The light, optionally refracted from exiting face, leaves micro-prism 82 and impinges micro-prism 84. The light impinging micro-prism 84 is reflected from micro-prism 84 and leaves micro-prism pair 82 and 84 with deflected direction.

It is evident that many other variation and alternatives for similar optical manipulations are possible and apparent to those skilled in the art by selecting materials, material's coating, optical elements, etc.

In an exemplary embodiment of the present invention, the optical sub-elements are any small footprint optical element, i.e. small enough to fit into the size of the pixels/sub-pixels area on the display. Optical sub-element may be any refracting, diffracting and reflecting elements such as prisms, lenses, mirrors, diffraction grading optics, kinoforms, short waveguides, etc.

In an exemplary embodiment of the present invention, the display comply with the needs of vision impaired people, Optionally, the same display comply with the needs of people with different vision impairments, as well as people with normal vision. For example, the optical sub-elements are designed for creating a virtual image of the display in a manner an observer who suffers from long sightedness, such as Hyperopia, perceives the distance of the display as more distant than it really is. In another example, the optical sub-elements are designed for creating a virtual image of the display in a manner an observer who suffers from short sightedness, such as Myopia, perceives the distance of the display as less distant than it really is.

In an exemplary embodiment of the present invention, the display is designed for stereoscopic viewing, e.g. displaying 3D images.

In an exemplary embodiment of the present invention, the display is designed to project light to one or more selected viewing angles. Such a feature is desired for security of the information the user is viewing since concentrating the light energy to one direction reduces the light which is projected to other directions, hence reduces the visibility of the image from respective angles.

In an exemplary embodiment of the present invention, the display is designed to operate in highly illuminated surrounding environment. By having an element that may be toggled between regular viewing and reduced field of view viewing, the apparent brightness of the screen may be highly increased, thus enabling the user to view the display in situation of high background light.

In an exemplary embodiment of the present invention, the display is designed to toggling the use of the display between normal and stereoscopic viewing.

### EXAMPLES

Reference is now made to the following examples, which together with the above descriptions illustrate some embodiments of the present invention in a non limiting fashion.

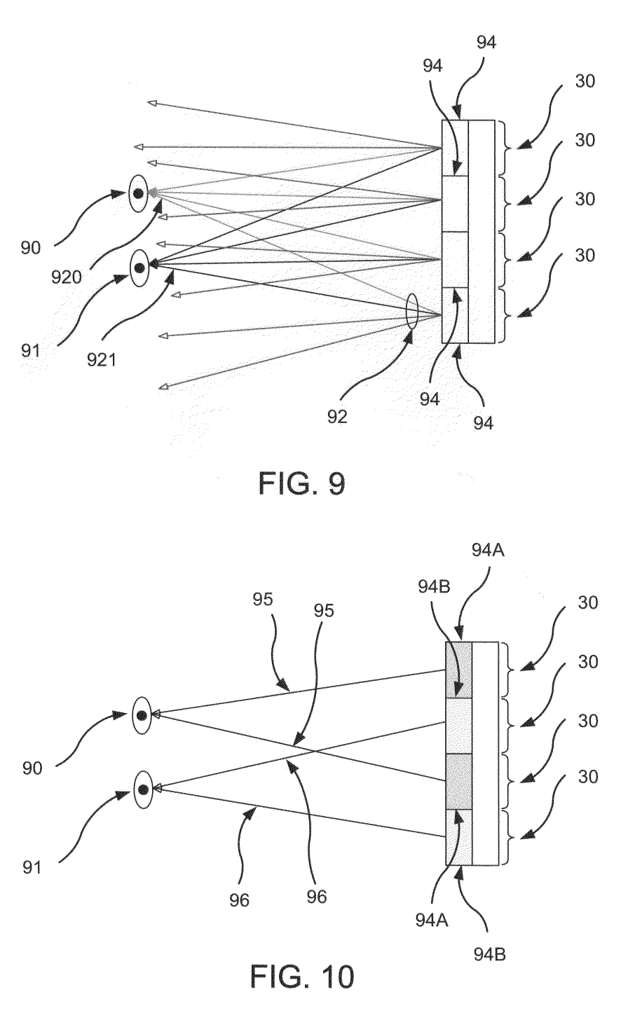

In an exemplary embodiment of the present invention, multi-mode 2D\3D display is demonstrated. 2D display mode is illustrated in FIG. 9. For the sake of clarity, a display with only four pixels 30 is presented. The light projected from each pixel 30 is passing through optical sub-element 94. Each optical sub-element 94 having 3 states: “2D”, “3DL” (3D for the left eye) and “3DR” (3D for the right eye). In 2D mode the light projected from each optical sub-element 94 spread in wide beam 92. One ray of wide beam 92, ray 920 is projected towards the observer's left eye 90, and one ray of wide beam 92, ray 921, is projected towards the observer's right eye 91. Overall, same image is projected to both eyes hence 2D image is built on observer's brain. No optical manipulation is done by optical sub-element 94 in 2D mode. Optionally, to implement the lack of optical manipulation in this mode, optical sub-element 94 comprises several sub-elements; each covers only dead-zones of pixel 30 in 2D mode.

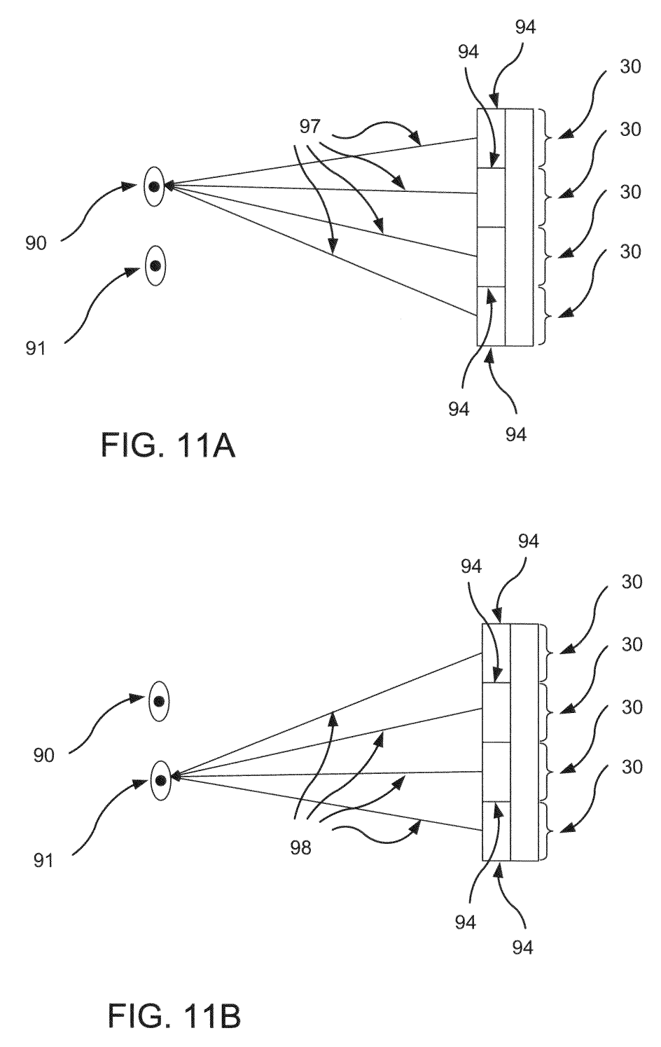

FIGS. 10 and 11, illustrate 3D mode operation of the display according to an exemplary embodiment of the present invention. FIG. 10 illustrates space interlaced 3D mode and FIG. 11 illustrates time interlaced 3D mode. Reference is now made to FIG. 10. The optical sub-elements are space interlaced into two groups: optical sub elements 94A and optical sub-elements 94B. Both optical sub-elements 94A and 94B are projecting a narrow light beam. Optical sub elements 94A are set to state “3DL” hence diffract the light beams 95 towards the observer's left eye 90. Optical sub elements 94B are set to state “3DR” hence diffract the light beams 96 towards the observer's right eye 91.

The plurality of monochromatic light beams may be generated by the sub-pixels of pixels 30 in a manner that allows forming a chromatic image of the media data on each one of the observer's eyes. When the images are properly generated (stereoscopic images), a 3D image is built on observer's brain.

Reference is now made to FIGS. 11A-11B which illustrate time interlaced 3D mode, according to some embodiments of the present invention. FIG. 11A illustrates the light projection in the even time slots and FIG. 11B illustrate the light projection in the odd time slots. In FIG. 11A optical sub-elements 94 are set to state “3DL” hence all optical sub-elements diffract the light beams 97 towards the observer's left eye 90. In FIG. 11B Optical sub elements 94 are set to state “3DR” hence all optical sub-elements diffract the light beams 98 towards the observer's right eye 91. In the above embodiment, when the two images, i.e., odd and even time slots images, are properly generated (stereoscopic images), a 3D image is built on observer's brain.

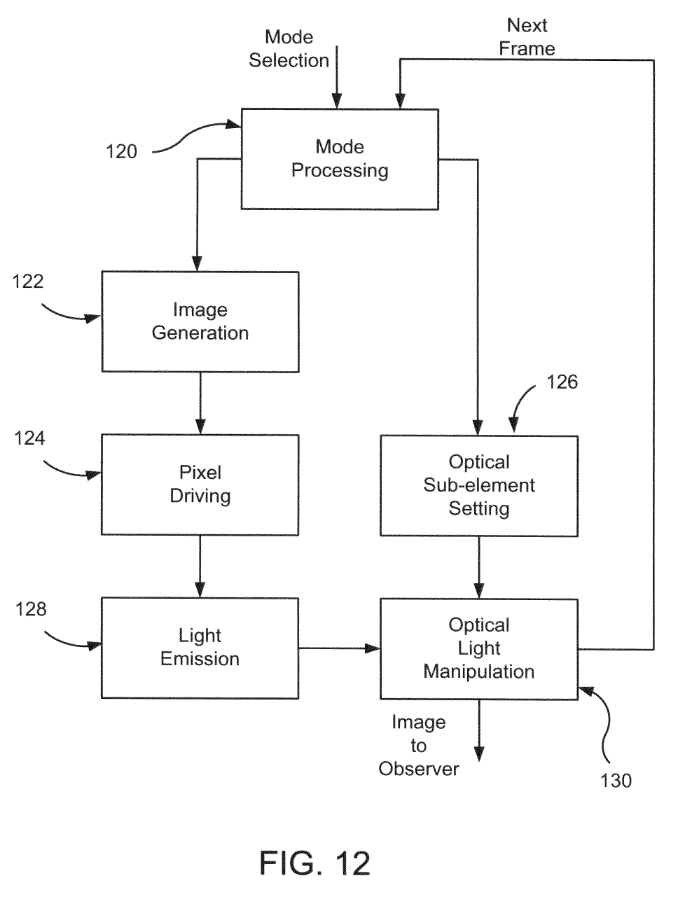

Reference is now made to FIG. 12, which is a flowchart of a method for implementing 3D display, according to one embodiment of the present invention. First the mode of operation: 2D, 3D pixel interlacing or 3D time interlacing is determined. A mode processing step 120 analyze the type of action need to be taken based on the mode and the time slot (even or odd). Mode processing instruct image generation step 122 to generate any one of 2D image, 3D right eye image, 3D left eye image or both pixel interlaced 3D right and left eye images. The generated image or images is driven to appropriate pixels (and sub-pixels) in pixel driving step 124. In parallel, based on the mode processing step 120 instructions in the optical setting step 126 the optical sub-elements are set to the correct setup, i.e. any one of 2D, 3DR or 3DL state. The light emitted from the pixels are manipulated (e.g., diffracted) by the optical sub-elements in optical light processing step 130. The image, i.e. the light projected after optical light processing step 130 is observed by the display's observers. The process repeats itself on a frame by frame basis.

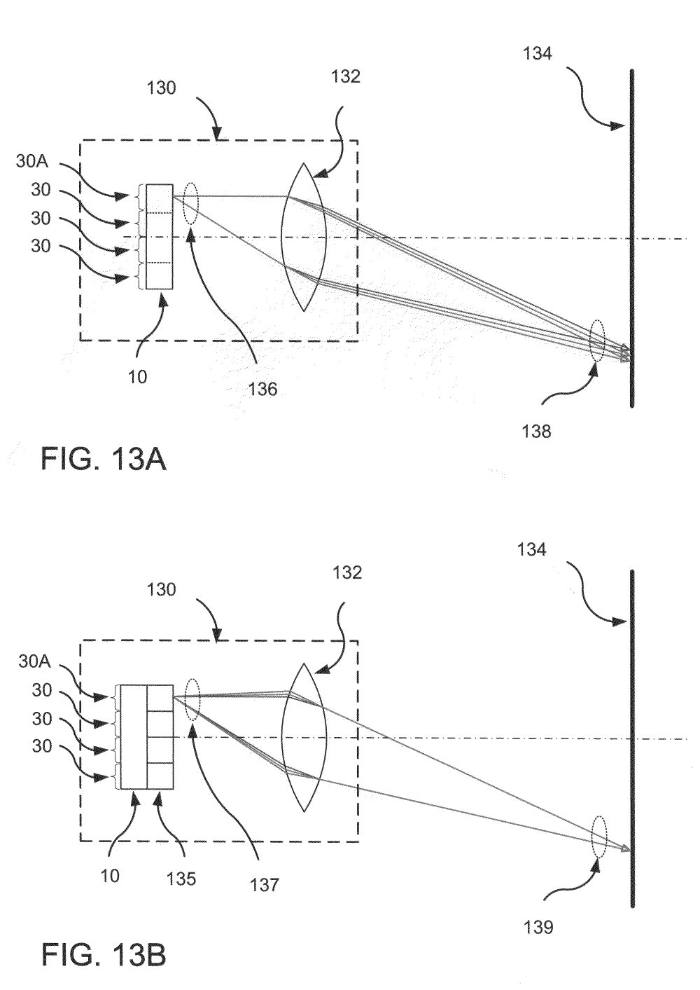

Reference is now made to FIGS. 13A and 13B, which are schematic illustrations of a lateral color aberration correction in an image projector, according to some embodiments of the present invention. FIG. 13A illustrates light trajectory of lateral aberration that is created by the projector's lens before using lateral correction and FIG. 13B illustrates light trajectory with correction. FIG. 13A illustrates an image projector 130 comprising of a display 10 and a lens 132. The image is projected toward a screen 134. For clarity, display 10 includes four exemplary pixels 30 and exemplary light trajectories from the top pixel 30A are presented. The light beam 136 projected from the top pixel 30A toward lens 132. Light beam 138 projected from the lens 132 toward screen 134. The distance between the screen 134 and the projector is defined according to the focal point of the image. It should be noted that the refractive index of the lens 132 may be wavelength dependent and therefore each monochromatic color deflects in a different angle in relation to lens 132, affecting the focal point of the image that is projected on the screen. In FIG. 13B, image projector 130 comprises display 10, lens 132, and an optical element 135 that comprises optical sub-elements, which are positioned in front of the monochromatic sub-pixels of the display 10, according to some exemplary embodiment of the present invention. The optical element 135 deflects the light from display 10 toward lens 132, as shown at 137. The light 137 is deflected with a different angle than beam 136 in FIG. 13A. Consequently, light beam 139 impinges screen 134 with monochromatic components which are focused on a common location on screen 134. In similar manner, optical element 135 may correct or reduce other chromatic aberrations, such as axial, longitudinal and/or transverse chromatic aberrations. Optionally, a monochromatic kinoform is added in order to correct monochromatic aberrations. For instance, the monochromatic kinoform is used for correcting monochromatic aberrations such as piston, tilt, defocus, spherical, coma, astigmatism, curvature of field and/or image distortion.

In some embodiments of the present invention, the optical sub-elements include one or more DOEs for narrowing the spectral bandwidth of the monochromatic beam. As the aberration of each monochromatic component is estimated more precisely than the aberration of white light, such narrowing enables a relatively accurate aberration correction.

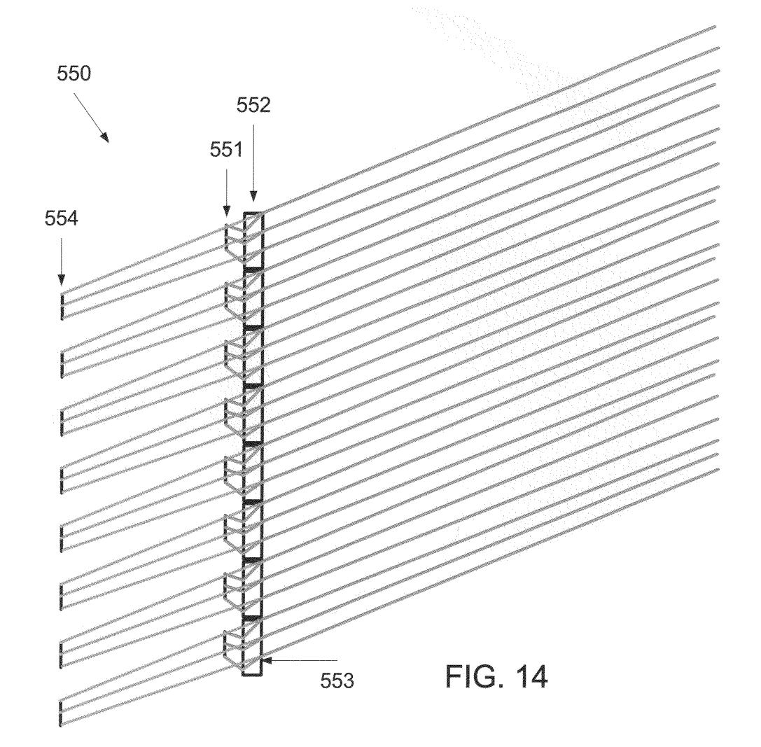

Reference is now made to FIG. 14, which is a schematic illustration of an imaging device 550, such as a display or a screen of a handheld device, such as a cellular phone or a PDA, according to some embodiments of the present invention. The imaging device 550 is used for manipulating a perceived distance of a display 551 that comprises an array of picture elements, such as pixels, each optionally based one or more R,G, and/or B sub-pixels, for example as depicted in FIG. 3A. The imaging device 500 comprises the display 551, and an optical element 552 designed for separately diffracting light emitted from each one of the pixels or sub pixels toward a point of view (POV) in a manner that the diffraction of light manipulates the perceived distance of the display for an observer at the POV, optionally as described below. Optionally, the optical element 552 is positioned in a distance of between 10 micrometer (μm) and 100 μm from the display 551. Optionally, the optical element 552 and the display 551 are integrally connected.

Optionally, the light manipulation element diffracts the light emitted from the display in a manner an observer at the POV perceives the distance of the display as more or less distant than it really is. For example, as shown at 554, which is a virtual presentation of the display 551, the perceived distance of the display 551 is more distant than it really is.

Optionally, the optical element 552 is an array that comprises plurality of optical sub-elements, for example as shown at 553, which are positioned in front of the pixels, for example as shown in one or more of FIGS. 4 and 5.

Each optical sub-element 553 diffracts the light waves which are coming therethrough from the sub pixels by taking advantage of the diffraction phenomenon. In particular, each optical sub-element 553 is a substrate or an array of substrates on which complex microstructures, which may be referred to as grooves, are created to modulate from both sides. Each optical sub-element 553 diffracts impinging light from a respective pixel or sub pixel by modifying their wavefronts by interference and/or phase control. As the impinging light waves pass through the optical sub-element 553, their phase and/or their amplitude may be changed according to the arrangement of the complex microstructures. The optical sub-element 553 comprises from each side one or more holographic transmission gratings with linear grooves, holographic transmission gratings with circular grooves, blazed gratings, multilevel phase relief DOE, kinoform structure gratings, and sinusoidal gratings. It should be noted that each optical sub-element 553 may be replaced with a set of a plurality of DOEs, each separately engraved in a similar manner to the respective side.

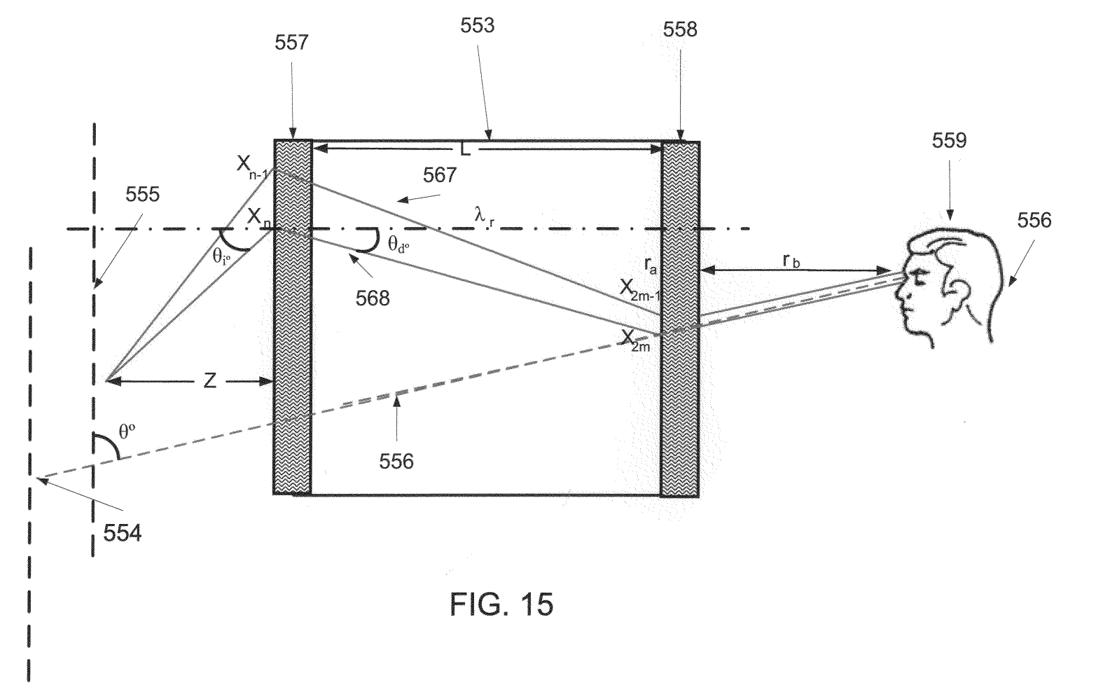

Reference is now also made to FIG. 15, which is a schematic illustration of an exemplary optical sub-element 553 that is positioned in front of a picture element 55 of the display 551 of the imaging device 550 of FIG. 14, according to one embodiment of the present invention. The picture element 555, which may be one or more pixels or sub pixels, is positioned approximately or exactly in parallel to the exemplary optical sub-element 553 and an observer 559 that is positioned in the imaging device POV 556. For brevity, in the description below is related to a pixel 555; however any other picture element, such as a sub pixel or a number of sub pixels may be used.

Each side of the optical sub-element 553 comprises one or more transmission gratings with linear grooves 557, 558. FIG. 15 further depicts two exemplary trajectories 567, 568 of two light waves, which are emitted from the pixel 555 and diffracted toward the imaging device POV 556 by the optical sub-element 553. FIG. 2 further depicts a virtual line of sight (LOS) 566 between the imaging device POV 556 of the observer 559 and the origin of the two light waves 567, 568 which is the pixel 555.

The two sides of the optics sub-elements 557, 558 converge light emitted from the exemplary optical sub-element 553 in a double diffraction process, for example as described in Provisional patent application Ser. No. 12/007,879 filed on Jan. 16, 2008, which is incorporated herein by reference. In this embodiment, a set of luminous rays exiting from the pixel 555 impinges the first side 557 of the exemplary optical sub-element 553, for example as shown at points Xₙ₋₁, Xₙ that denote the impinging points of light wave n and n-1 at the first side of the exemplary optical sub-element 553.

Reference is now made to an arithmetical presentation of the diffraction made by the first and second sides 557, 558 of the optics sub-element 553. The description of following section is provided with reference to a trajectory of a light wave that is emitted from the pixel 555. It should be noted that though FIG. 15 depicts only one exemplary trajectory of one light wave, the pixel 555 emits a plurality of light waves which are manipulated in a similar manner.

The diffraction of an incident light wave, which is emitted from the pixel 555, by the first side of the optics sub-element 557, may be described as follows according to the grating equation:

sin θᵢ+sin θ_{d}=2λN [1]

Where λ denotes the wavelength of the light wave, N denotes the grating frequency, θᵢ denotes an angle of incidence of the light wave with the first side of the optics sub-element 557, and θ_{d} denotes the angle in which the size of the diffractive optics sub-element 557 diffracts the light wave, both in relation to a perpendicular to the first side of the optics sub-element 557, for example as shown at 208. In FIG. 15 θᵢ and θ_{d} should be between the ray and the normal to the grating.

The diffraction of the light wave, which is defined in equation 1, may be described as follows:

$$\frac{{x}_{1 n}}{\sqrt{{x}_{1 n}^{2} + {Z}^{2}}} + \frac{{x}_{1 n} - {x}_{2 m}}{\sqrt{{( {x}_{1 n} - {x}_{2 m} )}^{2} + {L}^{2}}} = 2 {λ}_{n} N \qquad [ 2 ]$$

where Z denotes the distance between the pixel 555 and the first side of the diffractive optics sub-element 557, L denotes the distance between the sides of the optics sub-element 557, 558, as depicted in FIG. 15, and λₙ denotes the wavelength of ray xₙ.

At the atom level, the second side of the optics sub-element 557 diffracts an incident light wave that is received from the diffraction of a first side of the optics sub-element 557. Optionally, second side of the optics sub-element 557 is defined as follows:

$$\frac{{x}_{1 n} - {x}_{2 m}}{\sqrt{{( {x}_{1 n} - {x}_{2 m} )}^{2} + {L}^{2}}} + \frac{{r}_{a} - {x}_{2 m}}{\sqrt{{( {r}_{a} - {x}_{2 m} )}^{2} + {r}_{b}^{2}}} = {λ}_{n} N \qquad [ 3 ]$$

where rₐ denotes the coordinates of the second side of the optics sub-element 558 and r_{b} denotes the coordinates of the observer 559 at the imaging device POV 103.

Equations 1-3 are written for the first and second orders However, in the second order, where the diffraction efficiency of more than 80% is unachievable under scalar approximation theory. As commonly known, according to scalar theory, the diffraction efficiency around the second order is zero for the phase level of DOEs and therefore only around the first order we can achieve high diffraction efficiencies. Thus, applying it to orders is feasible under scalar theory and manufacturing processing under specific groove densities.

In an exemplary embodiment of the present invention, the first side of the optics sub-element 557 has a holographic grating with 3000 lines per millimeter and the holographic gratings of the second side of the optics sub-element 558 has 1000 lines per millimeter. The second order diffraction of the first side of the optics sub-element 557 and the first diffraction order of the second side of the optics sub-element 558 correspond with equations 1-4 which are provided above. In the first side of the optics sub-element 557, D equals to ˜3.3×10⁻⁴ mm and in the second side of the optics sub-element 5 58, D equals to ˜10×10⁻⁴ mm. The effective area of each grating is ˜35 mm×45 mm, which is optionally the size of mobile display. The sides of the optics sub-element 557, 558 are positioned in parallel to one another and the distance between them, which is denoted by L in FIG. 2, is 3 mm.

As further described in described in Provisional patent application Ser. No. 12/007,879 filed on Jan. 16, 2008, which is incorporated herein by reference, such an embodiment may be used for changing the perceived distance of a display, such as a display for people how suffer from Hyperopia, which is also known as hypermetropia or colloquially as farsightedness or longsightedness. For example, in Hyperopia, the power of the cornea and lens is insufficient to keep an image of objects that move towards the eye on the retina and these objects may appear blurred. By using such an imaging device 550, an observer that suffers from Hyperopia may perceive the pixel 555, which is optionally a display, such as a white light display of a cellular phone or a PDA, at a longer distant than it is really is, for example as shown at 554. Such a perception allows the corneas and lenses of the observer's eyes to keep an image of pixel 555 in focus.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the present invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the present invention, which are, for clarity, described in the context of separate embodiments, may also be provided in combination in a single embodiment. Conversely, various features of the present invention, which are, for brevity, described in the context of a single embodiment, may also be provided separately or in any suitable subcombination or as suitable in any other described embodiment of the present invention. Certain features described in the context of various embodiments are not to be considered essential features of those embodiments, unless the embodiment is inoperative without those elements.

Although the present invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. An apparatus for displaying media data, comprising:
a digital display configured for emitting a plurality of monochromatic light beams to produce a chromatic image of the media data; and
an optical element configured for diffracting said plurality of monochromatic light beams to form a plurality of monochromatic images of the media data;
wherein said chromatic image and each said monochromatic image having substantially equal resolution.

2. The apparatus of claim 1, wherein said optical element configured is configured for diffracting one of said plurality of monochromatic images toward a left eye of an observer and a second of said plurality of monochromatic images toward a right eye of said observer.

3. The apparatus of claim 1, wherein said digital display comprises a plurality of sub pixels each configured for separately emitting one of said plurality of monochromatic light beams.

4. The apparatus of claim 3, wherein a first group of said plurality of sub pixels is configured for emitting light centered on a first wavelength and a second group of said plurality of sub pixels is configured for emitting light centered on a second wavelength, said optical element configured for diffracting each said monochromatic light beam according to respective said first or second wavelength.

5. The apparatus of claim 1, wherein said plurality of monochromatic images are diffracted to merge to form an additional chromatic image.

6. The apparatus of claim 1, wherein said optical element comprises of plurality of optical sub-elements overlaying said display.

7. The apparatus of claim 6, wherein each said optical sub-element is associated with a different pixel of said display, each said optical sub-element being positioned to diffract light emitted from said associated pixel.

8. The apparatus of claim 6, wherein at least one of said plurality of optical sub-elements is associated with a different group of adjacent pixels of said display, each said at least one optical sub-element being positioned to diffract light emitted from said different group of pixels.

9. The apparatus of claim 8, wherein each said at least one optical sub-element is configured for diffracting said emitted light to a plurality of directions.

10. The apparatus of claim 6, wherein at least one of said optical sub-element is associated with a different chromatic sub-pixel element of a pixel of said display, each said at least one optical sub-element being positioned to diffract light emitted from said associated chromatic sub-pixel.

11. The apparatus of claim 6, wherein said optical sub-elements have a movement capability relative to the said display.

12. The apparatus of claim 11, wherein said movement capability allows each said optical sub-element to move separately from each other.

13. The apparatus of claim 11, wherein said movement capability is configured to displace at least one of said plurality of optical sub-elements between overlaying an active area of said display and a passive area of said display.

14. The apparatus of claim 1, wherein said optical element comprises at least one micro-prism.

15. The apparatus of claim 1, wherein said optical element comprises at least one diffraction grating optical element.

16. The apparatus of claim 1, wherein said optical element comprises first and second groups of a plurality of optical sub-elements, each optical sub-element of said first group being configured for diffracting one of said plurality of monochromatic light beams toward a first direction and each optical sub-element of said second group being configured for diffracting at least one of said plurality of monochromatic light beams toward a second direction.

17. The apparatus of claim 16, wherein said first and second groups are arranged in a single layer.

18. The apparatus of claim 2, wherein said optical element creates a stereoscopic 3D display.

19. The apparatus of claim 1, wherein said digital display comprises a plurality of picture elements and said optical element comprises a plurality of sub elements each associated with a receptive said picture element, each said sub element being configured for diffracting a plurality of light waves emitted from said respective picture element toward a POV, thereby manipulating a perceived distance of said digital display for an observer at said POV, said perceived distance being different from said actual distance.

20. The apparatus of claim 19, wherein each said picture element is a pixel.

21. The apparatus of claim 19, wherein each said picture element is a sub-pixel.

22. A method for displaying media data, comprising:
emitting a plurality of monochromatic light beams to produce a chromatic image of the media data; and
diffracting said plurality of monochromatic light beams to form a plurality of monochromatic images of the media data;
wherein said chromatic image and each said monochromatic image having substantially equal resolution.

23. The method of claim 22, wherein said diffraction of said plurality of monochromatic light beams is performed by plurality of optical sub-elements.

24. The method of claim 22, further comprising moving an optical element for changing the position of at least one of said plurality of monochromatic images.

25. The method of claim 24, wherein said optical element comprises a plurality of optical sub elements, said moving comprises moving a group of said optical sub elements for changing the position of a selected image of said plurality of monochromatic images.

26. The method of claim 25, wherein said moving comprises moving said group from an active area to a passive area.

27. The method of claim 22, wherein a first group of said plurality of monochromatic light beams are refract toward a left eye of an observer and second group of said plurality of monochromatic light beams being refract toward a right eye of said observer, wherein said first and second groups form a stereoscopic 3D image of said media data.
